SEQUENCE LISTING (14 sequences)

SEQ ID NO: 1 - DNA, 16 bp, Unknown
  Exemplary construct
gtaagatccgctacaa

SEQ ID NO: 2 - DNA, 23 bp, Unknown
  Exemplary construct
atccgctaatgcgccgtagtccg

SEQ ID NO: 3 - DNA, 16 bp, Unknown
  Exemplary construct
aaaaaaaaaaaaaaaa

SEQ ID NO: 4 - DNA, 16 bp, Unknown
  Exemplary construct
aaaaaaaaaaaaaaat

SEQ ID NO: 5 - DNA, 16 bp, Unknown
  Exemplary construct
aaaaaaaaaaaaaata

SEQ ID NO: 6 - DNA, 16 bp, Unknown
  Exemplary construct
aaaaaaaaaaaaaatt

SEQ ID NO: 7 - DNA, 16 bp, Unknown
  Exemplary construct
gtaagatccgctacat

SEQ ID NO: 8 - DNA, 16 bp, Unknown
  Exemplary construct
gtaagatccgctacta

SEQ ID NO: 9 - DNA, 16 bp, Unknown
  Exemplary construct
cgcccccccccccccg

SEQ ID NO: 10 - DNA, 16 bp, Unknown
  Exemplary construct
cgccccccccccccgc

SEQ ID NO: 11 - DNA, 16 bp, Unknown
  Exemplary construct
cgcccccccccccccc

SEQ ID NO: 12 - DNA, 16 bp, Unknown
  Exemplary construct
cccccccccccccccc

SEQ ID NO: 13 - DNA, 16 bp, Unknown
  Exemplary construct
attgcttccatgggtc

SEQ ID NO: 14 - protein, 108 aa, Unknown
  Exemplary construct
DVQMIQSPSSLSASLGDIVTMTCQASQGTSINLNWFQQKPGKAPKLLIYGSSNLEDGVPSRFSGSRYGTDFTLTISSLEDEDLATYFCLQHSYLPYTFGGGTKLEIKR

(19) United States
(12) Patent Application Publication
(10) Pub. No.: US 2017/0124253 A1
(43) Pub. Date: May 4, 2017

(54) FOOD PATHOGEN BIOINFORMATICS

(71) Applicant: NOBLIS, INC., Falls Church, VA (US)

(72) Inventors: Sterling THOMAS, Woodbridge, VA (US); Karen TAYLOR, Alexandria, VA (US)

(73) Assignee: NOBLIS, INC., Falls Church, VA (US)

(21) Appl. No.: 15/337,754

(22) Filed: Oct. 28, 2016

Related U.S. Application Data
(60) Provisional application No. 62/247,588, filed on Oct. 28, 2015.

(51) Int. Cl. G06F 19/22; G06F 19/28

(52) U.S. Cl. CPC G06F 19/22; G06F 19/28

(57) ABSTRACT

Systems and methods for identifying pathogens in food using whole genome sequencing are provided. In some embodiments, gene sequence data derived from food pathogen samples are subject to bioinformatics processing in order to align the sequences and detect single-nucleotide polymorphisms (SNP's). In some embodiments, a SNP matrix is generated and a phylogenic tree is created, and it is determined whether the strain of pathogens detected in one food pathogen sample is the same strain of pathogen present in other previously-encountered food pathogen samples. If a match between samples is determined, then metadata associated with the matching samples is leveraged to trace the spread of the strain through a supply chain in space and time, and parties associated with the matching samples may be notified.

### RELATED APPLICATIONS

This application claims priority to U.S. Provisional Application Ser. No. 62/247,588 filed Oct. 28, 2015, titled “FOOD PATHOGEN BIOINFORMATICS,” which is hereby incorporated by reference in its entirety.

### FIELD

This relates to systems and methods for identifying pathogens in food using whole genome sequencing.

### BACKGROUND

Food pathogens present major threats to public health and to the economy. An outbreak of a deadly food pathogen can cause hundreds of millions of dollars in economic damage stemming from recalls of food products, destroyed supply, lost production time, and brand equity loss. Furthermore, food pathogen outbreaks can present serious health threats: in just one 2012 Salmonella outbreak stemming from contaminated peanut butter, 10 people were hospitalized and another 32 became ill across 20 states. In a 2015 Salmonella outbreak stemming from tainted cucumbers, over 700 people in 35 states became ill, and four deaths were reported. Thus, food safety and food biosecurity are of critical importance to public health and to economic stability. Food biosecurity is an element of biodefense, which includes protecting our food supply from bioterrorism as well as from accidental or natural contamination.

Traditional microbiological detection methods require days or even weeks to identify a causative agent in food contamination. Current methods for identifying food pathogens may require that sequenced genomic reads be subjected to assembly and/or annotation, requiring long periods of time before pathogens can be effectively identified. Further, current methods for identifying food pathogens are unable to quickly or effectively identify food pathogens at the strain level, and thereby are unable to differentiate from distinct sources of similar pathogens, and are unable to precisely pinpoint the origin of a contaminant strain in a supply chain.

### SUMMARY

Accordingly, there is a need for improved methods of analyzing food pathogens to identify and classify pathogens on the strain level, to precisely locate the source of food contamination in space and time, to recognize relations among food contamination events separated in space and/or time, to analyze newly-available samples to determine strain-level relations between pathogens in real-time, and to quickly and effectively notify parties of information required to remediate a food contamination event.

Hardware and software infrastructure is needed to access information representing food contaminant isolates, sequence genomic information from the food contaminant isolates, align sequenced genomic information, identify single-nucleotide polymorphisms (SNP's) in the sequenced genomic information, and generate and store data representing food contaminant genomes including the identified SNP's. Hardware and software infrastructure is needed to collect metadata regarding locations, times, parties, facilities, supply chains, transportation means, and equipment associated with analyzed food pathogens, and to associate and store this metadata with stored information representing the food contaminant genomes. Hardware and software infrastructure is needed to compare derived and stored information representing one food contaminant with derived and/or stored information representing other food contaminants, in order to determine whether food contaminants are associated with the same strain of contaminant, such that it may be determined whether geographically or temporally distinct food contamination events are attributable to the same outbreak or are traceable to a common physical source. Hardware and software infrastructure is needed to transmit compressed information representing food contaminant genomes to parties that are determined to be associated with the food contaminant, and to anonymize metadata such that sensitive information regarding food contamination events and parties is not disclosed along with the compressed representation of a food contaminant.

Disclosed herein are systems and methods for analyzing food pathogens to recognize relationships among food pathogen samples provided from spatially or geographically distinct sources, and to determine whether the food pathogens are of the same or a similar strain. In some embodiments, a rapid-post-processing bioinformatics computer is capable of receiving gene sequence data and analyzing the gene sequence data to recognize SNP's (single-nucleotide polymorphisms) and to determine whether the gene sequence data represents the same strain as food pathogens from other sources. In some embodiments, the bioinformatics computer may store processed genomic information in a private and secure database, such that parties associated with pathogen samples that are determined to match one another may be notified of the existence of a match, the need to contact one another, the nature of the match, the extent or nature of a contamination event, or remediation information.

In some embodiments, the bioinformatics computer may be communicatively connected via public or private computer networks to a plurality of remote computer systems associated with food sources and/or sequencing facilities and laboratories; in some embodiments, the bioinformatics computer may include a memory storing rapid post-sequencing bioinformatics analysis software, and the computer may receive and automatically retrieve available genetic information from a variety of sources, including the different remote food source computers, the different remote, sequencing computer, and/or public databases or public agencies concerned with genomic information. Upon receiving and/or automatically retrieving genetic information (e.g., raw reads), the bioinformatics computer may automatically analyze the information in order to detect SNP's and to identify the pathogen(s) represented by the data on the strain level; the system may automatically compare the received and analyzed data to stored data in the private database and/or in public databases, and may perform analyses such as harnessing a SNP matrix and generating a phylogenic tree in order to determine whether the received data corresponds to the same strain as any other data previously stored or contemporaneously received. That is, the bioinformatics computer may determine whether the same strain of pathogen is associated with different samples, and may accordingly determine whether different samples are attributable to the same contamination event.

In some embodiments, when the bioinformatics computer determines that multiple samples are associated with a same or similar strain and/or are associated with the same contamination event, certain non-confidential information (e.g., metadata and/or genomic information) may be retrieved from the database and automatically shared with the parties associated with the matching data by public or private network connections. Quickly making information about matching strains available to all parties associated with the same contamination event may speed the process of locating the contamination source in a supply chain, correctly identifying affected products and facilities, and allowing for rapid collaboration between all affected parties on remediation efforts and procedures.

In some embodiments, a first bioinformatics system comprises: a first food pathogen source associated with a first party; a second food pathogen source associated with a second party; and a bioinformatics processing facility communicatively coupled with the first food source and the second food source, wherein the bioinformatics processing facility comprises one or more processors configured to: receive first genomic sequence data comprising a plurality of subsequences, wherein the first genomic sequence data is derived from a first food pathogen associated with the first party; align the plurality of subsequences with a reference nucleic acid sequence, wherein the reference nucleic acid sequence is represented by an index; identify one or more single nucleotide-polymorphisms in the first genomic sequence data; compare, based on at least one of the identified single-nucleotide polymorphisms, the first genomic sequence data to second genomic sequence data derived from a second food pathogen associated with the second party; and based on said comparison, determine whether the first food pathogen and the second food pathogen are of a same strain.

In some embodiments of the first bioinformatics system, the one or more processors are configured to: provide a database storing genomic sequence data representing a plurality of food pathogens, wherein the data is represented by reference to the index; wherein the database comprises stored metadata linking the genomic sequence data to one or more of the first party, a location, a time, and a third party, and wherein comparing the first genomic sequence data to the second genomic sequence data comprises accessing the second genomic sequence data in the database.

In some embodiments of the first bioinformatics system, the one or more processors are configured to: in response to determining that the first food pathogen and the second food pathogen are of the same strain, consult metadata to determine whether it is permissible to share non-confidential information about the related first and second food pathogens with the first and second parties; if it is permissible to share non-confidential information about the related first and second food pathogens with the first and second parties, automatically transmit data to the first party indicating that the first food pathogen is associated with the second food pathogen, and automatically transmitting data to the second party indicating that the second food pathogen is associated with the first food pathogen.

In some embodiments of the first bioinformatics system, transmitting data comprises transmitting a compressed representation of one of the first or second genomic sequence data.

In some embodiments of the first bioinformatics system, comparing the first genomic sequence data to second genomic sequence data comprises constructing a matrix of common single nucleotide polymorphisms between the first and second genomic sequences, and generating a phylogenic tree.

In some embodiments of the first bioinformatics system: the first genomic sequence data is first gene sequence data; and the second genomic sequence data is second gene sequence data.

In some embodiments, a method for identifying pathogens in food using whole genome sequencing is performed, the method comprising: receiving first genomic sequence data comprising a plurality of subsequences, wherein the first genomic sequence data is derived from a first food pathogen associated with a first party; aligning the plurality of subsequences with a reference nucleic acid sequence, wherein the reference nucleic acid sequence is represented by an index; identifying one or more single nucleotide-polymorphisms in the first genomic sequence data; comparing, based on at least one of the identified single-nucleotide polymorphisms, the first genomic sequence data to second genomic sequence data derived from a second food pathogen associated with a second party; and based on said comparison, determining whether the first food pathogen and the second food pathogen are of a same strain.

In some embodiments, the method comprises: providing a database storing genomic sequence data representing a plurality of food pathogens, wherein the data is represented by reference to the index; wherein the database comprises stored metadata linking the genomic sequence data to one or more of the first party, a location, a time, and a third party, and wherein comparing the first genomic sequence data to the second genomic sequence data comprises accessing the second genomic sequence data in the database.

In some embodiments, the method comprises: in response to determining that the first food pathogen and the second food pathogen are of the same strain, consulting metadata to determine whether it is permissible to share non-confidential information about the related first and second food pathogens with the first and second parties; if it is permissible to share non-confidential information about the related first and second food pathogens with the first and second parties, automatically transmitting data to the first party indicating that the first food pathogen is associated with the second food pathogen, and automatically transmitting data to the second party indicating that the second food pathogen is associated with the first food pathogen.

In some embodiments of the method, transmitting data comprises transmitting a compressed representation of one of the first or second genomic sequence data.

In some embodiments of the method, comparing the first genomic sequence data to second genomic sequence data comprises constructing a matrix of common single nucleotide polymorphisms between the first and second genomic sequences, and generating a phylogenic tree.

In some embodiments of the method: the first genomic sequence data is first gene sequence data; and the second genomic sequence data is second gene sequence data.

In some embodiments, a non-transitory computer-readable storage medium comprises instructions that, when executed by a processor, cause the processor to: receive first genomic sequence data comprising a plurality of subsequences, wherein the first genomic sequence data is derived from a first food pathogen associated with a first party; align the plurality of subsequences with a reference nucleic acid sequence, wherein the reference nucleic acid sequence is represented by an index; identify one or more single nucleotide-polymorphisms in the first genomic sequence data; compare, based on at least one of the identified single-nucleotide polymorphisms, the first genomic sequence data to second genomic sequence data derived from a second food pathogen associated with a second party; and based on said comparison, determine whether the first food pathogen and the second food pathogen are of a same strain.

In some embodiments of the non-transitory computer-readable storage medium, the instructions cause the processor to: provide a database storing genomic sequence data representing a plurality of food pathogens, wherein the data is represented by reference to the index; wherein the database comprises stored metadata linking the genomic sequence data to one or more of the first party, a location, a time, and a third party, and wherein comparing the first genomic sequence data to the second genomic sequence data comprises accessing the second genomic sequence data in the database.

In some embodiments of the non-transitory computer-readable storage medium, the instructions cause the processor to: in response to determining that the first food pathogen and the second food pathogen are of the same strain, consult metadata to determine whether it is permissible to share non-confidential information about the related first and second food pathogens with the first and second parties; if it is permissible to share non-confidential information about the related first and second food pathogens with the first and second parties, automatically transmit data to the first party indicating that the first food pathogen is associated with the second food pathogen, and automatically transmitting data to the second party indicating that the second food pathogen is associated with the first food pathogen.

In some embodiments of the non-transitory computer-readable storage medium, transmitting data comprises transmitting a compressed representation of one of the first or second genomic sequence data.

In some embodiments of the non-transitory computer-readable storage medium, comparing the first genomic sequence data to second genomic sequence data comprises constructing a matrix of common single nucleotide polymorphisms between the first and second genomic sequences, and generating a phylogenic tree.

In some embodiments of the non-transitory computer-readable storage medium: the first genomic sequence data is first gene sequence data; and the second genomic sequence data is second gene sequence data.

In some embodiments, a transitory computer-readable storage medium comprises instructions that, when executed by a processor, cause the processor to: receive first genomic sequence data comprising a plurality of subsequences, wherein the first genomic sequence data is derived from a first food pathogen associated with a first party; align the plurality of subsequences with a reference nucleic acid sequence, wherein the reference nucleic acid sequence is represented by an index; identify one or more single nucleotide-polymorphisms in the first genomic sequence data; compare, based on at least one of the identified single-nucleotide polymorphisms, the first genomic sequence data to second genomic sequence data derived from a second food pathogen associated with a second party; and based on said comparison, determine whether the first food pathogen and the second food pathogen are of a same strain.

In some embodiments of the transitory computer-readable storage medium, the instructions cause the processor to: provide a database storing genomic sequence data representing a plurality of food pathogens, wherein the data is represented by reference to the index; wherein the database comprises stored metadata linking the genomic sequence data to one or more of the first party, a location, a time, and a third party, and wherein comparing the first genomic sequence data to the second genomic sequence data comprises accessing the second genomic sequence data in the database.

In some embodiments of the transitory computer-readable storage medium, the instructions cause the processor to: in response to determining that the first food pathogen and the second food pathogen are of the same strain, consult metadata to determine whether it is permissible to share non-confidential information about the related first and second food pathogens with the first and second parties; if it is permissible to share non-confidential information about the related first and second food pathogens with the first and second parties, automatically transmit data to the first party indicating that the first food pathogen is associated with the second food pathogen, and automatically transmitting data to the second party indicating that the second food pathogen is associated with the first food pathogen.

In some embodiments of the transitory computer-readable storage medium, transmitting data comprises transmitting a compressed representation of one of the first or second genomic sequence data.

In some embodiments of the transitory computer-readable storage medium, comparing the first genomic sequence data to second genomic sequence data comprises constructing a matrix of common single nucleotide polymorphisms between the first and second genomic sequences, and generating a phylogenic tree.

In some embodiments of the transitory computer-readable storage medium: the first genomic sequence data is first gene sequence data; and the second genomic sequence data is second gene sequence data.

In some embodiments, a system comprises: means for receiving first genomic sequence data comprising a plurality of subsequences, wherein the first genomic sequence data is derived from a first food pathogen associated with a first party; aligning the plurality of subsequences with a reference nucleic acid sequence, wherein the reference nucleic acid sequence is represented by an index; identifying one or more single nucleotide-polymorphisms in the first genomic sequence data; comparing, based on at least one of the identified single-nucleotide polymorphisms, the first genomic sequence data to second genomic sequence data derived from a second food pathogen associated with a second party; and based on said comparison, determining whether the first food pathogen and the second food pathogen are of a same strain.

In some embodiments, the system comprises means for: providing a database storing genomic sequence data representing a plurality of food pathogens, wherein the data is represented by reference to the index; wherein the database comprises stored metadata linking the genomic sequence data to one or more of the first party, a location, a time, and a third party, and wherein comparing the first genomic sequence data to the second genomic sequence data comprises accessing the second genomic sequence data in the database.

In some embodiments, the system further comprises means for: in response to determining that the first food pathogen and the second food pathogen are of the same strain, consulting metadata to determine whether it is permissible to share non-confidential information about the related first and second food pathogens with the first and second parties; if it is permissible to share non-confidential information about the related first and second food pathogens with the first and second parties, automatically transmitting data to the first party indicating that the first food pathogen is associated with the second food pathogen, and automatically transmitting data to the second party indicating that the second food pathogen is associated with the first food pathogen.

In some embodiments of the system, transmitting data comprises transmitting a compressed representation of one of the first or second genomic sequence data.

In some embodiments of the system, comparing the first genomic sequence data to second genomic sequence data comprises constructing a matrix of common single nucleotide polymorphisms between the first and second genomic sequences, and generating a phylogenic tree.

In some embodiments of the system: the first genomic sequence data is first gene sequence data; and the second genomic sequence data is second gene sequence data.

In some embodiments, a second bioinformatics system comprises: a first computer associated with a first food pathogen; a second computer associated with a second food pathogen; and a bioinformatics computer, communicatively coupled with the first and second computers, wherein the bioinformatics computer comprises one or more processors configured to: receive, from the first computer, first genomic sequence data associated with the first food pathogen; in response to receiving the first and second genomic sequence data: align subsequences of the first genomic sequence data with a reference nucleic acid sequence, wherein the reference nucleic acid sequence is represented by an index; identify one or more single-nucleotide polymorphisms in the first genomic sequence data; and store a representation of the first genomic sequence data; receive, from the second computer, second genomic sequence data associated with the first food pathogen; and in response to receiving the second genomic sequence data: align subsequences of the second genomic sequence data with the reference nucleic acid sequence; identify one or more single-nucleotide polymorphisms in the second genomic sequence data; store a representation of the second genomic sequence data; compare, based on at least two of the identified single-nucleotide polymorphisms, the first genomic sequence data to second genomic sequence data; based on said comparison, determine whether the first food pathogen and the second food pathogen are of a same strain; and if the first food pathogen and the second food pathogen are determined to be of the same strain: automatically transmitting data to indicating that the first food pathogen is associated with the second food pathogen, and automatically transmitting data indicating that the second food pathogen is associated with the first food pathogen.

In some embodiments of the second bioinformatics system: automatically transmitting data to indicating that the first food pathogen is associated with the second food pathogen comprises transmitting data to a third computer associated with a source of the first food pathogen; and automatically transmitting data indicating that the second food pathogen is associated with the first food pathogen comprises transmitting data to a fourth computer associated with a source of the second food pathogen.

In some embodiments of the second bioinformatics system the first computer is a sequencing computer that generates the first genomic sequence data; and the second computer is a sequencing computer that generates the second genomic sequence data.

In some embodiments of the second bioinformatics system: the first genomic sequence data is first gene sequence data; and the second genomic sequence data is second gene sequence data.

### BRIEF DESCRIPTION OF THE DRAWINGS

FIG. 1 is a block diagram showing a system for food pathogen bioinformatics.

FIG. 2 is a block diagram of an index of reference permutations of nucleic acid sequence portions.

FIG. 3 is a flow diagram depicting a method for identifying pathogens in food using whole genome sequencing.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

Traditional methods for genome-based detection of foodborne biological contaminants or food pathogens are time-consuming and imprecise. First, traditional methods rely on a weeks-to-months-long process that includes assembling and annotating genomic sequence data in order to generate useful results. In this amount of time, contaminations can continue to spread through food distribution pipelines, or food operations/businesses may be forced to remain shut down and lose profits. Second, traditional methods for identification of foodborne biological contaminants or food pathogens are imprecise and are unable to effectively identify and differentiate food pathogens on the strain level. This imprecision can lead to the inability to conclude that spatially or temporally distinct contamination events are linked by the same pathogen strain, and the resulting inability to search for a common source. Furthermore, this imprecision can lead to false-positive results when lab cross-contamination causes a food pathogen sample to test positive to a similar but non-identical food pathogen as the pathogen for which testing is being performed; without the capability for strain-level differentiation, false-positive test results attributable to lab cross-contamination may cause food that is in fact not contaminated to be destroyed in response to a false-positive test result. Third, without strain-level identification techniques, current techniques for analysis of food pathogens may be unable to trace the evolution of foodborne pathogens over space and time, on the SNP level, in order to trace the source of a contamination event. For example, traditional pulsed-field gel electrophoresis (PFGE) subtyping methods may be unable to reliable distinguish the specific strain responsible for an outbreak, may be time-consuming and prone to operator error, and may be unable to identify certain strain types.

Accordingly, improved systems and methods are herein provided for analyzing food pathogens to characterize pathogens at the strain level by harnessing high-throughput whole genome sequencing (WGS) technology and bioinformatics analysis that recognizes and analyzes single-nucleotide polymorphisms to identify food pathogens on the strain level. The improved systems and methods provided herein may allow for precisely locating the source of food contamination in space and time, recognizing relations among food contamination events separated in space and/or time, and quickly and effectively notifying parties of information required to remediate a food contamination event. In some embodiments, these systems and methods are provided by a system including a comprehensive and rapid post-sequencing bioinformatics tool, such as Noblis' BioVelocity tool. In some embodiments, these systems and methods are provided by way of a collaborative foodborne-pathogen-traceback system that includes a rapid post-sequencing bioinformatics computer communicatively coupled with various food source computers and/or various sequencing computers (such as computers at gene sequencing laboratories). In some embodiments, the bioinformatics computer receives and collects food pathogen samples and/or digital genomic food pathogen information from geographically dispersed participants (e.g., food sources, sequencing laboratories), performs WGS and bioinformatics analysis on the received information, stores the processed information in a private and secure central database for comparison, and distributes information about the relationships among various spatially and/or temporally distinct contamination events to associated participants, including information about contaminated food pathogen samples that may be attributable to a common source. In some embodiments, the bioinformatics computer is communicatively coupled by a computer network to a variety of computer systems that may provide or make available genetic information in various formats; the genetic information may be received or automatically retrieved, and the bioinformatics computer may automatically process and analyze newly-received genetic information and compare it to all previously-stored and/or contemporaneously received genetic information, in order to determine which if any other food samples contain contaminants of the same strain. Upon concluding that two contaminants are of the same strain, the bioinformatics computer may automatically transmit relevant, non-confidential genetic information and metadata to the computer systems of parties associated with matching samples.

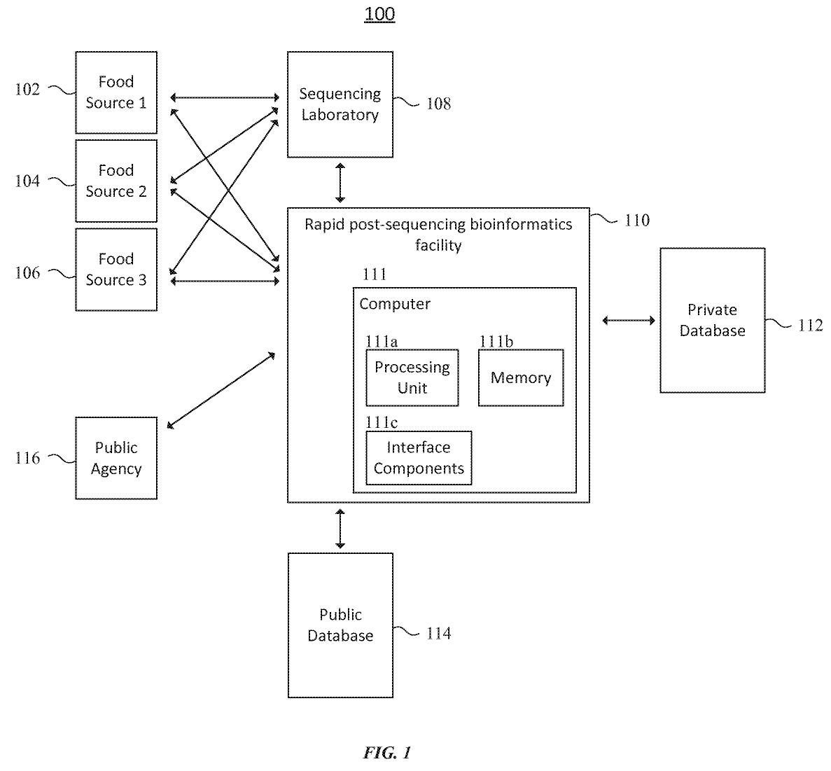

Below, FIGS. 1-3 provide a description of exemplary systems and methods for performing the techniques for analyzing food pathogens to characterize pathogens at the strain level, precisely locating the source of food contamination in space and time, recognizing relations among food contamination events separated in space and/or time, analyzing newly-available samples to determine strain-level relations between pathogens in real-time, and quickly and effectively notifying parties of information required to remediate a food contamination event, as disclosed herein.

Although the following description uses terms first, second, etc., to describe various elements, these elements should not be limited by the terms. These terms are only used to distinguish one element from another.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

FIG. 1 shows an exemplary foodborne-pathogen-traceback system 100 that is configured to perform one or more software processes that, when executed, provide one or more aspects of the disclosed embodiments. FIG. 1 is not intended to be limiting to the disclosed embodiment, as the components used to implement the processes and features disclosed herein may vary.

As shown in FIG. 1, in accordance with some embodiments, a system may be provided that facilitates communication between food source computers, sequencing computers, a rapid post-sequencing bioinformatics computer, private and public database computers, and public agency computers.

In some embodiments, system 100 includes various food sources computers 102a-102c, which may be a computer system or server system associated with any food source such as any party or facility that provides food pathogen isolates or food pathogen samples for analysis. For example, a food source may include a farm, a ranch, a slaughterhouse, a packaging facility, a processing facility, a factory, a distribution facility, a shipping terminal, a warehouse, a transportation hub, a store, a market, a restaurant, a laboratory, or the like. Food sources computers 102a-102c may be associated with food sources that are geographically dispersed from one another or that may be located adjacent to or inside one another. Food source computers 102a-102c may be communicatively coupled by a public or private electronic communication network with one another, and may similarly be communicatively coupled with sequencing computers 108a-c and/or rapid post-sequencing bioinformatics computer 111, as shown in FIG. 1. Food source computers 102a-102c may be associated with food sources that are connected by transportation/shipping channels or pipelines to one another or that are connected by transportation/shipping channels to facilities or laboratories associated with sequencing computers 108a-c and/or facilities associated with rapid post-sequencing bioinformatics computer 111.

In some embodiments, traceback system 100 includes sequencing computers 108a-108c, which may associated with facilities or laboratories that receive food pathogen samples provided by the food sources associated with food source computer 102a-102c, and extract genomic sequence data (e.g., reads) from the food pathogen samples. In some embodiments, sequencing computers 108a-108c may be contained within or associated with a facility associated with food source computers 102a-102c or bioinformatics computer 111. In some embodiments, as depicted in FIG. 1, sequencing computers 108a-108c may be associated with distinct, independent, third-party sequencing laboratories that is physically distinct from one another and from bioinformatics computer 111.

In some embodiments, system 100 includes rapid post-sequencing bioinformatics computer 111, which may be any computer system or server system that receives food pathogen samples and/or digital genomic sequence information (e.g., “reads”) and processes the genomic sequence information to identify SNP's, identify strains of food pathogens, and compare strains of food pathogens to previously-analyzed or previously-identified strains in order to determine whether there is a match among strains from different samples.

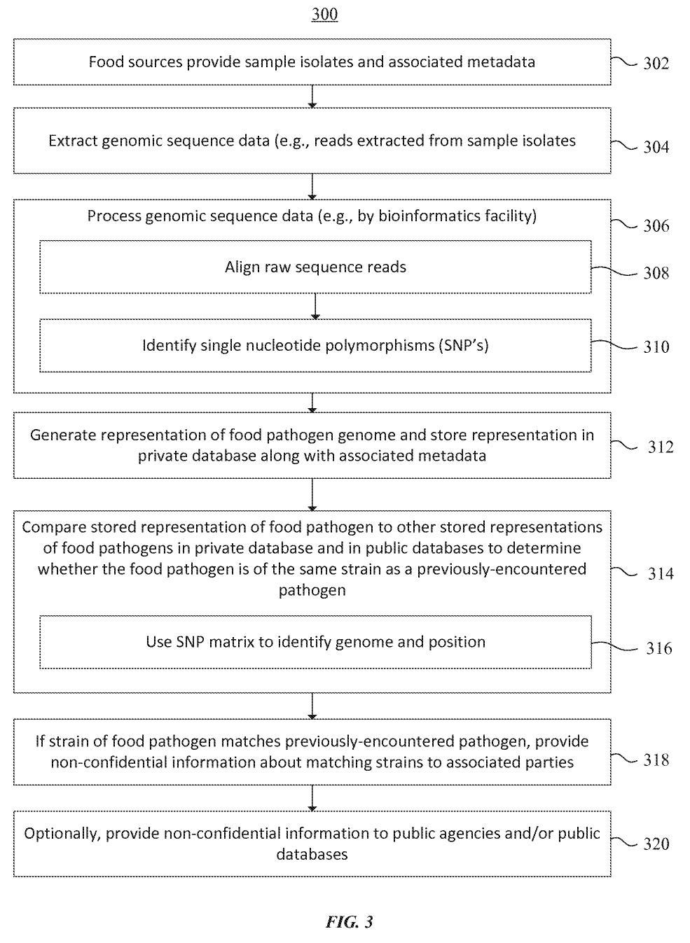

In some embodiments, computer 111 may be configured to actively monitor remote computers and computer systems to which it is communicatively connected in order to automatically detect and/or retrieve newly-available genomic information; in some embodiments, computer 111 may passively receive genomic information that is transmitted to it by a communicatively coupled computer. In some embodiments, upon receiving and/or automatically retrieving genomic information from a remote computer such as any one or more of food source computers 102a-c or sequencing computers 108a-c, computer 111 may automatically engage in bioinformatics analyses of the data received, including the identification of SNP's in the data received, the identification of a strain of the food pathogen represented by the data received, and the determination of whether the food pathogen represented by the data received is of the same strain and/or contamination event of any other food pathogen data previously received/stored or contemporaneously received. In this way, computer 111 may automatically recognize when two pathogens from distinct samples are related to the same contamination event, and may automatically transmit the genomic information and relevant metadata to parties associate with the matching contaminants. An exemplary process related to these functions is explained in greater detail below with respect to FIG. 3.

In some embodiments, bioinformatics computer 111 includes components to process, transmit, provide, and receive information consistent with the disclosed embodiments. Computer 111 may include computer system components, such as one or more servers, desktop computers, workstations, tablets, hand-held computing devices, memory devices, and/or internal network(s) connecting the components. In some embodiments, computer 111 may be a server that includes one or more processors, memory devices, and interface components 111c. For example, computer 111 may include processing unit 111a, memory 111b, and interface components 111c. Computer 111 may be a single server or may be configured as a distributed computer system including multiple servers or computers that interoperate to perform one or more of the processes and functionalities associated with the disclosed embodiments.

Processing unit 111a may include one or more known processing devices, such as a microprocessor from the Pentium™ family manufactured by Intel™ or the Turion™ family manufactured by AMD™. Processing unit 111a may include a single core or multiple core processor system that provides the ability to perform parallel processes simultaneously. For example, processing unit 111a may include a single core processor that is configured with virtual processing technologies known to those skilled in the art. In certain embodiments, processing unit 111a may use logical processors to simultaneously execute and control multiple processes. The one or more processors in processing unit 111a may implement virtual machine technologies, or other similar known technologies to provide the ability to execute, control, run, manipulate, store, etc., multiple software processes, applications, programs, etc. In another embodiment, processing unit 111a may include a multiple-core processor arrangement (e.g., dual or quad core) that is configured to provide parallel processing functionalities to allow computer 111 to execute multiple processes simultaneously. Other types of processor arrangements, such as those used in Cray supercomputers, could be implemented to provide for the capabilities disclosed herein.

In some embodiments, computer 111 may be a supercomputer, such as the Cray XMT or Cray XMT 2. Supercomputers may include multiple-core processor arrangements, paired with a memory, that are configured to provide greater parallel processing functionalities relative to consumer-grade desktop computers, laptops, and the like. The Cray XMT, for example, may include 128 TB (terabytes) of memory and processor cores capable of executing up to 8,192 threads in parallel. Similarly, the Cray XMT 2 may include 512 TB of memory and 128 processor cores, with each processor core capable of executing 128 threads, for a total of 16,384 threads.

Computer 111 may include one or more storage devices configured to store information used by processing unit 111a (or other components) to perform certain functions related to the disclosed embodiments. In one example, memory 111b may include instructions to enable the one or more processors in processing unit 111a to execute one or more applications, such as server applications, network communication processes, and any other type of application or software known to be available on computer systems. Alternatively, the instructions, application programs, etc., may be stored in an external storage or available from a memory over a public or private network to which computer 111 is communicatively coupled. The one or more storage devices may be a volatile or non-volatile, magnetic, semiconductor, tape, optical, removable, non-removable, or other type of storage device or tangible computer-readable medium.

In some embodiments, memory 111b may include instructions that, when executed by the one or more processors in processing unit 111a, perform one or more processes consistent with the functionalities disclosed herein. Methods, systems, and articles of manufacture consistent with disclosed embodiments are not limited to separate programs or computers configured to perform dedicated tasks. For example, computer 111 may include a memory that may include one or more programs to perform one or more functions for identifying and classifying pathogens on the strain level, precisely locating the source of food contamination in space and time, recognizing relations among food contamination events separated in space and/or time, and quickly and effectively notifying parties of information required to remediate a food contamination event. Moreover, the one or more processors in processing unit 111a may execute one or more programs located remotely from computer 111 and/or system 100. For example, computer 111 may access one or more remote programs, that, when executed, perform functions related to disclosed embodiments. Memory 111b may include one or more memory devices that store data and instructions used to perform one or more features of the disclosed embodiments. Memory 111b may also include any combination of one or more databases controlled by memory controller devices (e.g., server(s), etc.) or software, such as document management systems, Microsoft SQL databases, SharePoint databases, Oracle™ databases, Sybase™ databases, or other relational databases. In some embodiments, memory 111b contains private database 112, which is shown separately in FIG. 1 and discussed further below.

Computer 111 may also be communicatively connected to one or more memory devices (e.g., databases (including but not limited to private database 112 and public database 114)) locally or through a public or private network. The remote memory devices may be configured to store information and may be accessed and/or managed by computer 111. By way of example, the remote memory devices may be document management systems, Microsoft SQL databases, SharePoint databases, Oracle™ databases, Sybase™ databases, or other relational databases. Systems and methods of disclosed embodiments, however, are not limited to separate databases or even to the use of a database.

Computer 111 may also include one or more I/O devices that may comprise one or more interfaces for receiving signals or input from input devices and providing signals or output to one or more output devices that allow data to be received and/or transmitted by electronic computing system 100. For example, interface components 111c may provide interfaces to one or more input devices, such as one or more keyboards, mouse devices, and the like, that enable computer 111 to receive data from one or more users. Further, interface components 111c may include components configured to send and receive information between components of computer 111 or external to computer 111.

In some embodiments, computer 111 may create, receive, store, and/or provide one or more indexes of a nucleic acid sequence or an amino acid sequence. Any such index may include a plurality of elements, with each element corresponding to a permutation of a nucleic acid sequence or an amino acid sequence (or another type of sequence). Computer 111 may implement the index using a variety of data structures, such as databases, matrices, arrays, linked lists, trees, and the like. The choice of data structures may vary and is not critical to any embodiment. Computer 111 may store the index in memory 111c and/or in private database 112. More specifically, the index may be stored on hard disk; computer 111 may also load the index into RAM for increased performance.

An example nucleic acid sequence is shown in Table 1, below.

TABLE 1
Example Nucleic Acid Sequence
1234568790123456879012345687901234568790

ATTGCTTCCATGGGTC

As shown in Table 1, a nucleic acid sequence contains various combinations of the bases adenine, guanine, thymine, and cytosine, represented by the letters “A,” “G,” “T,” and “C,” respectively. The numerical digits included in Table 1 enable convenient identification of the positions of the different bases appearing in the sequence. For example, the base adenine appears in positions 1 and 10 of the sequence appearing in Table 1, which is 16 bases in length.

An example amino acid sequence is shown in Table 2, below.

TABLE 2
Example Amino Acid Sequence
1234568790123456879012345687901234568790

DVQMIQSPSSLSASLGDIVTMTCQASQGTSINLNWFQ
QKPGKAPKLLIYGSSNLEDGVPSRFSGSRYGTDFTLTI
SSLEDEDLATYFCLQHSYLPYTFGGGTKLEIKR

As shown in Table 2, an amino acid sequence may contain various combinations of the bases, as represented by the one-letter abbreviations for the standard amino acids. The amino acid sequence shown in Table 2 recites amino acids selected from the 22 standard (proteinogenic or natural) amino acids, but sequences comprising nonstandard amino acid sequences may also be used.

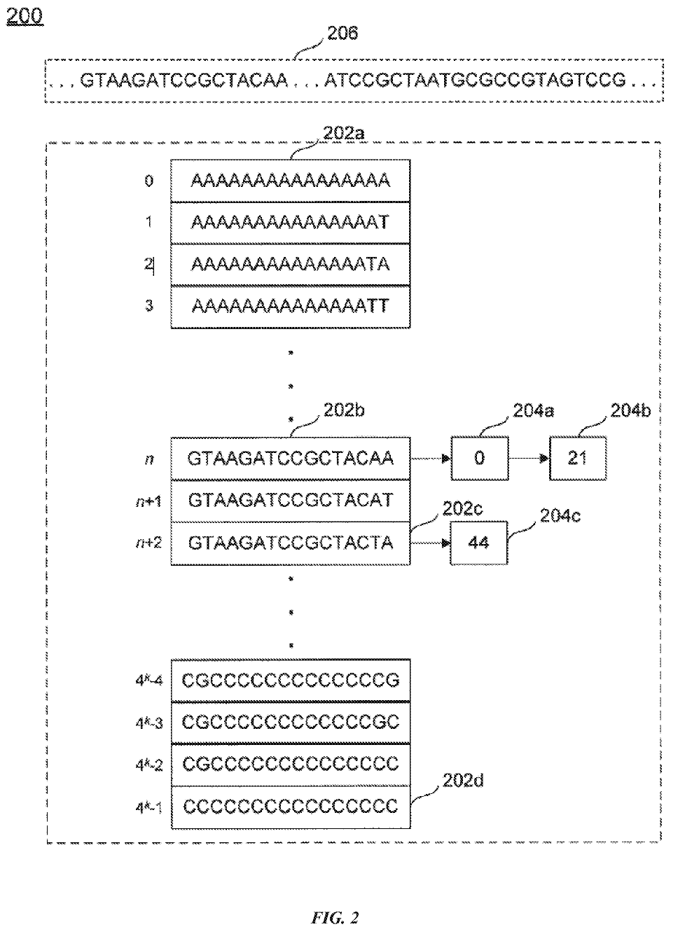

FIG. 2 illustrates an index 200 of a nucleic acid sequence, consistent with some embodiments disclosed herein. Although FIG. 2 illustrates use of nucleic acid sequences, such an example could apply to other types of sequences, such as RNA sequences (e.g., involving the bases adenine, guanine, uracil, and cytosine), sequences of artificially synthesized polymers (such as PNA), and amino acid sequences, including standard (proteinogeneic or natural) and non-standard (non-proteinogenic or non-natural) amino acids.

As shown in FIG. 2, index 200 includes a plurality of elements corresponding to various permutations of nucleic acid sequences. In the case of FIG. 2, each permutation is 16 bases in length, resulting in an index with 4¹⁶ or 4,294,967,296 elements (note that each base of a nucleic acid sequence is one of four types). More generally, the size or the number of elements of index 200 is equal to 4^{k}, where k is the length, in bases, of each permutation.

As shown to the left of each element in FIG. 2, a given element of the index may be referred to by its position number. For example, as illustrated in FIG. 2, position “0” refers to the element corresponding to the permutation “AAAAAAAAAAAAAAAA” (which is also indicated by reference number 202a), position “3” refers to the element corresponding to the permutation “AAAAAAAAAAAAAATT,” and position “n” refers to the element corresponding to the permutation “GTAAGATCCGCTACAA” (which is also indicated by reference number 202b). Because the index may have up to 4^{k} elements, as described above, the elements may be referenced beginning from position “0” to position “4^{k-1}.”

In some embodiments, index 200 may contain a number of elements fewer than the number of possible permutations of sequences of a predetermined length. For instance, computer 101a and/or 101b may use statistical and/or probabilistic methods to reduce the number of elements so that only certain nucleic acid sequences (e.g., those most likely to occur) are included in the index. Such an index has the potential advantage of increased computational efficiency and reduction in memory requirements.

Continuing on, reference numbers 202a, 202b, 202c, and 202d of FIG. 2 represent different elements (e.g., elements “0,” “n,” “n+2,” and “4^{k-1},” respectively) appearing in index 200. In some embodiments, reference numbers 204a, 204b, and 204c describe additional features of index 200. In particular, these reference numbers indicate position data corresponding to certain elements of the index, e.g., reference numbers 204a and 204b indicate position data stored in element 202b, and reference number 204c indicates position data stored in element 202c. In some embodiments, such as those in which the index includes reference numbers 204 or other position data, the index may provide information about one or more specific nucleic acid sequences; thus, the position data stored in an element may reflect a position or location of the nucleic acid sequence in which the corresponding permutation occurs. For instance, as shown in FIG. 2, reference numbers 204a and 204b indicate that the permutation corresponding to element n of the index, “GTAAGATCCGCTACAA,” appears beginning at positions “0” and “21” of the nucleic acid sequence 206. Similarly, reference number 204c indicates that the permutation corresponding to element n+2 of the index, “GTAAGATCCGCTACTA,” appears beginning at position “44” of the nucleic acid sequence 206.

The nucleic acid elemental sequences may be received from an underlying nucleic acid sample sequence, which may be much greater in length (e.g., millions or billions of bases).

Returning to FIG. 1, in some embodiments, system 100 includes private database 112, which may be any database configured to store digital information about food pathogen analysis performed by bioinformatics computer 111, including genomic information about food pathogen samples, metadata about food pathogen samples, and information indicating correspondence between different food pathogen samples, such as whether two or more samples are associated with the same cluster or strain.

In some embodiments, the genomic information stored in private database 112 may be in a format configured to be applied to an index, such as the index described above with respect to FIG. 2. In some embodiments, the genomic information stored in private database 112 may include location information, such as reference numbers 204, such that they may be applied against an index to determine which elements of the index constitute a genome of a food pathogen. In some embodiments, the information stored in private database 112 may be compressed information, such as any of the compressed information described in U.S. patent application Ser. No. 14/718,950, entitled “Compression and transmission of genomic information,” which is hereby incorporated by reference in its entirety. In some embodiments, private database 112 may include a stored generalized index such that compressed genomic information may be applied against the database's stored generalized index to be decompressed, such as described in U.S. patent application Ser. No. 14/718,950, as may be required.

In some embodiments, private database 112 may be included in bioinformatics computer 111, such as in memory 111b; and in some embodiments private database 112 may be physically separate but communicatively coupled, via public or private electronic networks, to bioinformatics computer 111. In some embodiments, private database 112 may be isolated from public networks, either by firewall and other network security protections, or by being physically decoupled from public networks, in order to increase data security of the confidential genomic information and metadata stored in private database 112.

In some embodiments, system 100 includes public database 114, which may be any public database configured to store digital information about food pathogens, including genomic information and metadata. In some embodiments, public database 114 may be accessible by public networks such as the internet. One example of a public database storing genomic information and metadata about known food pathogens includes GenomeTrakr (by the National Center for Biotechnology Information).

In some embodiments, system 100 includes public agency 116, which may be any public agency concerned with genomic information, food safety, food pathogens, or the like. For example, public agency may be the U.S. Food and Drug Administration, the National Center for Biotechnology Information at the U.S. National Institute of Health, or the U.S. Centers for Disease Control and Prevention. In some embodiments, bioinformatics computer 111 may be communicatively coupled with public agency 116 by public or private electronic networks, such as the internet.

FIG. 3 depicts a method for deriving and analyzing genomic information for food pathogens and for determining whether multiple food pathogen samples are associated with the same pathogen strain, in accordance with some embodiments. The method 300 may be performed by a system such as the system 100 described above with reference to FIG. 1. In the described embodiments, certain method steps are performed by certain parties or by certain system components; however, in other embodiments, each of the method steps may be performed by any of the other parties described herein, or the parties performing each step may be associated with one another, or may be a related party, or may be the same party.

As will be described below, the methods described herein, including exemplary method 300, may achieve fast, efficient, accurate, and precise derivation and analysis of genomic information of food pathogens, allowing for food pathogen genomic information to be compared to known food pathogen information, for clusters to be recognized, and for pathogen strains to be identified and tracked/traced in space and time. The methods may further allow for rapid transmission of genomic information and associated metadata to discrete parties associated with food pathogen samples that are determined to be associated with the same contamination event, such that parties' information may be kept confidential when no matches are determined, but may be shared on a limited basis if a matching pathogen is detected.

At step 302, food sources provide contaminant sample isolates or genomic data and associated metadata. In some embodiments, the food sources may be associated with any of food source computers 102a-102c discussed above with reference to FIG. 1. In some embodiments, food sources may transmit digital genomic information directly to a rapid post-sequencing bioinformatics computer, such as computer 111. In some embodiments, food sources may provide isolates themselves to either a bioinformatics facility or a sequencing laboratory, and the facility or laboratory may then derive sequence data (e.g., reads) itself or may arrange for a dedicated and/or third-party sequencing laboratory, such as a laboratory associated with one of sequencing computers 108a-c, to do so. In some embodiments, food sources may provide isolates to a dedicated and/or third-party sequencing laboratory.

The metadata provided by food sources may include any information associated with the food source, the food pathogen sample itself, or the pathogen or contamination that is known or expected to be associated with the sample. For example, critical metadata for a food pathogen sample may include the location and time at which the sample was taken. Additional metadata may include the identity of the food source party, the identity and relationship of any other associated parties, the type of sample, the manner in which the sample was collected, the party that collected the sample, the manner in which (and parties by which) the sample was transported, and the locations and routes along which the sample was transported, including the time at which the sample was present at each location. Additional metadata may include genomic information that is known or suspected about the food pathogen sample before sequencing and/or before post-sequencing bioinformatics processing, such as a known or suspected organism, known or suspected serovar, or other known or suspected genomic information.

Additional metadata may be generated by a sequencing laboratory, bioinformatics facility, transportation service, or any other party that comes in contact with or is associated with the sample. For example, a sequencing laboratory or bioinformatics facility may create and provide metadata tracking the time at which the sample was located at one or more facilities or locations, and the personnel that came into contact with the sample at various times. Furthermore, a transportation service may track the location of the sample while it is in transit, and may provide this information to the bioinformatics computer (alternately, the bioinformatics computer may actively retrieve such metadata itself).

Additional metadata may include confidentiality metadata indicating a confidentiality level of a food pathogen sample or of an associated party. A confidence level may indicate confidentiality procedures associated with a sample or with a party, including what information may permissibly be shared with what other parties, and when and how such information may be shared. Confidentiality metadata may further include an indication of how, with whom, and when certain information has been shared in the past, which may influence the determination or alteration of a confidentiality level. For example, a food source supplying a first food pathogen sample may indicate that the food pathogen sample is to be kept confidential from all third-parties, and confidentiality metadata may be created indicating that the food pathogen sample is to be kept confidential from all third-parties. If, however, at a future time, the food source agrees to share certain information with a specific third party, additional confidentiality metadata may be generated indicating that the information has been shared with that specific third party, and indicating whether the same information is approved to be shared with that same third party at a future time.

In some embodiments, metadata may be anonymized upon receipt. For example, computer 111 may process received metadata in order to anonymize it. In some embodiments, information about the identity of a party (such as a food source) may be deleted and/or scrubbed from memory, and only general information regarding the type of source (e.g., farm, restaurant, transportation facility, etc.), location of the source (possibly only indicating a wide geographic range), and time of receipt may be stored or retained. In some embodiments, parties may be identified in storage by anonymous identifiers in order to increase security, such that information indicating the name of the party is not stored in plain-text or human-readable format. In some embodiments, stored information may be encrypted.

At step 304, genomic sequence data (e.g., reads) are extracted from the sample isolates, wherein the genomic sequence data represents foodborne pathogens found in the sample isolates. In some embodiments, extracting sequence data is carried out by a sequencing laboratory that extracts sequence reads. In some embodiments, genomic sequence data may be in “FASTQ” or “FASTA” formats.

At step 306, the genomic sequence data extracted from the sample isolates is processed by a bioinformatics computer, such as computer 111 in FIG. 1. In some embodiments, the sequence data may be transmitted from any remote computer system to a bioinformatics computer system, such as by bioinformatics computer 111. In some embodiments, the bioinformatics computer may actively monitor, ping, or scrape known sources for genomic sequence data and may automatically retrieve such data when it becomes available. In some embodiments, the bioinformatics computer may automatically generate and/or retrieve metadata when retrieving and/or receiving genomic information. In some embodiments, in response to receiving and/or retrieving genomic sequence information, the bioinformatics computer may automatically process the genomic sequence information as described below.

In some embodiments, processing reads by a bioinformatics computer may include processing reads by a bioinformatics computer such as bioinformatics computer 111. In some embodiments, processing reads by a bioinformatics computer may include the application of assembly, annotation, and/or alignment algorithms to the raw read data. In some embodiments, assembly algorithms may be applied to sequenced reads without requiring assembly or annotation, which may greatly increase speed while maintaining fidelity. In some embodiments, processing reads by a bioinformatics computer may include aligning raw sequence reads and identifying SNP's, as shown in steps 308 and 310 in FIG. 3.

At step 308, raw sequence reads are aligned. In some embodiments, whole genome sequences may be aligned to a single reference genome, or may be aligned to an index of reference genomes (e.g., more than one genome). Raw sequence reads may be in “FASTQ” or “FASTA” formats.

Prior to aligning a read set using a reference index (such as the index shown in FIG. 2), the reference index may first be created. The reference index may consist of one or more reference genome FASTA file(s) that have been reduced into K-mers (sections of nucleotides of length=K, where the length is user-defined) and placed into a “bin” or corresponding address in memory. In some embodiments, K may be 16, meaning the index includes 16 nucleotide sections, or “16-mers.” The index structure may have the ability to utilize up to 4 TBs of RAM to store the index in memory, which may significantly increase the speed of the analysis, making such alignment and processing methods inherently fast. In some embodiments, for the reference index, nucleotides 1-16 of the genome may create the first K-mer, then nucleotides 2-17 may create the second K-mer, and so on and so forth, “sliding” one nucleotide at a time, creating a new K-mer until the last 16 nucleotides in the sequence. Each index created may be stored and reused for future alignments.

In some embodiments, the raw sequence reads in a read set may then undergo a simpler process where each read is “chopped” into K-mers (e.g., 16-mers), without “sliding.” This technique may decrease the number of alignments required per read, which may decrease the overall time for analysis. The alignment process consists of comparing each K-mer of the read set to the K-mers of the index.

In some embodiments, reads are chopped up into k-mers, but upon unsuccessful alignment through a k-mer, the k-mer is shifted down the read length-k, to avoid any nucleotides in the previous k-mer that may have caused an unsuccessful alignment.

If optional annotation of the sequence reads is performed, which is not required in all embodiments of processing reads, then the annotation process may be carried out by a bioinformatics computer following read alignment and before identification of SNP's.

In some embodiments, aligning sequence reads may be include or be preceded by a pre-processing step in which the reads are trimmed to acceptable quality levels, if a FASTQ file is used. In some embodiments, this pre-processing trimming step may be forgone if the reads are in a FASTA file format, as such a format does not have a quality scores. In some embodiments, read alignment includes the detection of inserts and/or deletes in the reference genome and/or read sequences.

At step 310, single nucleotide polymorphisms are identified. In some embodiments, a consensus reference is created from the aligned reads and compared to reference genomes in order to determine SNP locations. In some embodiments, a SNP identification algorithm may be used where a confidence threshold for identifying a SNP is implemented. For example, it may be required that a 95% consensus with at least 15× coverage is determined in order for a SNP to be indicated. That is, when performing SNP Analysis, aligned coverage may be calculated based on the number of reads aligned to a single position (nucleotide) of the reference genome. Once the position has been determined to have sufficient coverage (at least 15×), the aligned reads are then assessed to determine whether they have at least a consensus of 90% similarity and have a different nucleotide from the reference sequence to qualify as a SNP. The output generated by the processing by the bioinformatics computer may be a variant calling format (VCF) file comprised of each SNP and its corresponding position on the reference genome. Generally, the output produced may be any indication of the position of a SNP in a reference genome, and the identity of the nucleotide that comprises the SNP.

In some embodiments, processing reads by a bioinformatics computer may further include performing metagenomics analysis. When performing metagenomic analysis, a bioinformatics computer may compare a sample read set to multiple reference genomes (often different species) in a single index to determine which species is most closely related to the population by best alignment to the index. The result of the analysis may be a file containing information about alignment coverage of the analyzed read set to the index and providing statistics such as Perfect Aligned Reads %, Aligned Reads %, Number of SNPs, Perfect Alignments, Alignments, and Coverage (per base pair).

In some embodiments, identifying SNPs or otherwise processing reads by a bioinformatics computer may include one or more of the techniques disclosed in U.S. application Ser. No. 13/904,738, entitled “Systems and methods for SNP analysis and genome sequencing,” which is hereby incorporated by reference in its entirety.

At step 312, a representation is generated of the food pathogen genome, and the representation is stored in a private database along with associated metadata. For example, computer 111 may generate data representing the genome of the food pathogen represented by the sequence reads received from sequencing computer 108a, and may store that information in private database 112. In some embodiments, the representation created may include an index as discussed above with reference to FIG. 2. In some embodiments, the representation created may include location information such as reference numbers 204, which refer to an index such as the index shown I FIG. 2, and may be applied against such an index to determine which elements of the index constitute the genome of the food pathogen. In some embodiments, the information stored in private database 112 may be compressed information, such as any of the compressed information described in U.S. patent application Ser. No. 14/718,950. In some embodiments, the stored representation may include information in VCF file format.

In some embodiments, the metadata stored in the private database along with the derived representation of the food pathogen genome may be any of the metadata received from an outside party (e.g., from a food source, sequencing laboratory, or other party) or derived by a bioinformatics computer, as discussed above with reference to step 302. The metadata may be stored and indexed in a private database in any suitable manner such that the metadata may be accessed to determine the confidentiality level of the genomic information and of the metadata itself, accessed to determine information about the stored genomic information, compared to metadata associated with other stored genomic information stored either in the private database or elsewhere, and accessed to be modified to indicate additional or updated information about the stored genomic information.

At step 314, the stored representation of the food pathogen is compared to other stored representations of food pathogens in the private database and/or in public databases to determine whether the food pathogen is of the same strain as a previously encountered, otherwise known, or contemporaneously received pathogen. In some embodiments, upon generating/storing a representation of genomic information, the bioinformatics computer may automatically compare the newly generated/stored genomic information to all available genomic information, including all previously-stored information and all contemporaneously generated/stored information. In some embodiments, the automatic comparison may be made to less than all stored data, such as to all data within a predetermined timeframe, or all data associated with certain metadata (such as a certain organism).

In some embodiments, stored genomic information for one food pathogen may be compared to stored genomic information for all other known food pathogens to determine whether the genomic information indicates an identical genome. In some embodiments, stored genomic information for food pathogens may be compared on a base-by-base basis in order to determine whether the matching bases exceed a threshold number of matching bases, or whether they exceed a threshold percentage of matching bases. In some embodiments, the matching thresholds may be predetermined by the bioinformatics computer, may be set by a user or subscriber, or may be dynamically determined in accordance with available metadata indicating the time and location from which respective samples were taken. In some embodiments, if the matching threshold is exceeded by the number of matching bases, then two food pathogens may be determined to be of the same strain, and may therefore be determined to be attributable to the same contamination event. In some embodiments, comparing stored representations of food pathogens to one another may include using a SNP matrix to identify genomes and positions, as shown in step 316 of FIG. 3.

At step 316, a SNP matrix is used to identify genomes and positions. In some embodiments, the SNP's detected in step 310 may be indicated in a VCF file format. In some embodiments, the output indicating the detected SNP's may be incorporated into a SNP matrix. For example, in some embodiments, a python script may construct a matrix based on the common SNP's in VCF files; the SNP matrix may then be uploaded into MEGA (Molecular Evolutionary Genetics Analysis) to generate a phylogenetic tree for visualization. A phylogenic tree may allow inferences of samples with incomplete data, such as missing serovars.

In some embodiments, comparison of genomic information representing multiple food pathogens may include using a phylogenic approach to derive “clusters” of similar pathogens, such that pathogens attributable to different strains may be distinguished from one another, and the pathogens attributable to different contamination events may be distinguished from one another. For example, when multiple samples are contaminated with Salmonella, the samples may be separated into two or more clusters, indicating that there are two contamination sources, each constituting a distinct strain. Furthermore, relationships between detected serovars that are detected in different outbreaks at different time periods, such as years apart, may be recognized. In some embodiments, different contamination events may be distinguished by the location/positioning and amount of SNP's detected in different samples indicative of different serovars.

In some embodiments, comparison of genomic information stored in the databases, along with analysis of the associated metadata, may allow for spatial and temporal tracking of a detected cluster or strain. For example, if a unique strain of Salmonella is detected in samples provided by two geographically distinct entities, then the bioinformatics computer may determine that the strain must have a common source that is connected to the two entities. In a case where it is determined that no direct shipments are made from one entity to another, the computer may search stored metadata or publicly available information to determine an upstream common point where the strain may have affected both supply chains.

In some embodiments, the evolution of a recognized strain may be traced in space and time. For example, if similar strains are recognized in separate samples, the metadata applicable to each sample may show that the strain evolved at a certain point after the beginning of the contamination event. In some embodiments, if later samples are also analyzed and are determined to be attributable to the same strain or cluster, then the genomic similarities to one of the previously-recognized samples may allow for the determination that the new sample overlapped with the supply chains of the previously recognized samples at a certain point that is associated with the more similar sample.

At step 318, if the strain of a food pathogen matches a previously encountered pathogen, non-confidential information about the matching strains is provided to associated parties. For example, if it is determined that two samples are affected by the same strain or cluster of a pathogen (e.g., if the two samples are an exact genomic match or are a match above a matching threshold), and/or it is determined that two samples are affected by the same contamination event, then non-confidential information may be shared by bioinformatics computer 111 with the associated food sources or other parties. In some embodiments, when a strain match is determined, computer 111 may access the stored metadata in private database 112 or public database 114 that is associated with the matching samples, and may automatically transmit non-confidential information to any of computers 102a-c and/or 108a-c, if any of those computers are associated with the matching pathogens. For example, all information accessed in a public database may be automatically transmitted to any party associated with a matching strain to the strain stored in the public database. For information stored in a private database, metadata may be consulted to determine the confidentiality level of the genomic information and of the associated metadata. In accordance with the confidentiality level and/or with an explicit indication of whether (and with whom) the information may be shared, computer 111 may automatically transmit information to the computer systems of other parties affected by the same strain. Information transmitted to parties affected by the same strain or cluster of a food pathogen may include the identity of other affected parties, contact information for other parties, information about the time and location of previous contamination events, and/or information about remediation efforts previously undertaken by other parties.

In some embodiments, each affected party may receive a notification that a matching strain has been found in the database, and mutual permission may be sought for identity/contact information to be shared between the parties. In some embodiments, if one party approves the sharing of identity/contact information, then that party's information may automatically be shared with the other party. In some embodiments, only if both parties approve the sharing of identity/contact information will computer 111 automatically forward each party's information to the other.

In some embodiments, the genomic information itself may be automatically transmitted to parties affected by a strain or cluster when matching samples are found. In some embodiments, genomic information including a representation of the full or partial genome of the detected pathogen may be transmitted to the relevant parties. In some embodiments, this genomic information may be transmitted as compressed data in any of the manners described in U.S. patent application Ser. No. 14/718,950. In some embodiments, such information may automatically be sent in compressed form only to parties who are known to have access to an index that may be used to decompress the information. In some embodiments, the compressed information may be sent via email attachment. In some embodiments, non-compressed information may be transmitted to parties who do not have access to an index to decompress a compressed representation.

At step 320, optionally, non-confidential information is provided to public agencies and/or public databases. In some embodiments, organizations providing pathogen samples, such as food providers, may elect to share certain non-confidential information with public genomics databases and/or with public agencies such as the U.S. Food and Drug Administration, the National Center for Biotechnology Information at the U.S. National Institute of Health, or the U.S. Centers for Disease Control and Prevention. In such cases where sharing such information is approved, computer 111 may automatically transmit genomic information and/or metadata about detected pathogens to the appropriate parties. In some embodiments, the information may be transmitted in any of the manners discussed above with reference to step 318.

In some embodiments, computer 111 may generate a report that may be automatically transmitted to a computer of the party providing the sample (e.g., the food source), a party found to be associated with a matching sample, and/or a public agency or organization. In some embodiments, the report may include compressed or summarized genomic information; a name of the sample provided; a name of the pathogen organism; an identification of the strain, isolate, or cluster; geographic and temporal metadata; and any other metadata.

While reference is made herein to gene sequence data and to gene sequences, a person of ordinary skill in the art would readily appreciate that the systems, methods, and techniques described herein may be equally applicable, in some embodiments, to genomic sequence data and to genomic sequences in general.

### EXAMPLE 1

In 2012, a nationwide outbreak of Salmonella Bredeney occurred stemming from Valencia peanut butter products. This particular outbreak hospitalized 10 people while sickening another 32 people in 20 states, and resulted in the peanut butter manufacturer going out of business after losing over $2.5 million in contaminated product alone.

Noblis' BioVelocity post-sequencing bioinformatics tool was applied to thousands of Salmonella sequences present in the Food and Drug Administration's BioProject. In this analysis, BioVelocity was used to analyze 103 genomes directly related to peanut butter food sources and, specifically, the 2012 outbreak in 40 minutes. The runs used in our analysis were Illumina MiSeq sequenced 250 bp raw reads converted to FASTA format using the SRA toolkit, and were completed at a rate of 23.3 seconds/genome. The Salmonella enterica serovar Typhimurium str. LT2 (NT Accession AE006468.1) was the reference genome used for this analysis. After performing SNP Analysis using BioVelocity and constricting the SNP matrix, the results were uploaded into the MEGA6 tool for tree construction. As all of the sequences used in this analysis were from the same species, it was appropriate to use the Neighbor-Joining (NJ) method to estimate the phylogeny. The MEGA6 tool was used to construct and test a NJ tree using the concatenated SNP sequence matrix 1,2(Tamura,Saitou). The bootstrap method used 1000 replications to generate the branch clustering percentages 3(Felsenstein).

The resulting tree exhibited tight, distinct clade structures for the known serovars: Meleagrdis, Bredeney, Tennessee, Typhimurium, and Anatum. There were few instances of serovars clustering in multiple clades. For instance, one Bredeney serovar clustered with Meleagridis. Also, some Tennessee sequences clustered with or near Meleagridis, Typhimurium, and Anatum. The resulting clade for the IEH-NGS-SAL-01* strains suggests that they are of the Tennessee serovar, except for one clustering with the Bredeney clade. The FL FLDACS-* strains formed a unique clade with a position suggesting a close relationship to the Anatum clade and a closer one to a single Tennessee sequence.

It was observed that the outbreak cluster code “1208MLJBX-1” isolates had their own clade at the bottom of the tree. Eleven of the twelve isolates with this outbreak code clustered in this clade along with three others. Based on associated metadata, those isolates were determined to be from states (Virginia and Washington) that were affected and occurred during the 2012 peanut butter outbreak period. Even with partially complete metadata, it was inferred that the three isolates without the associated outbreak cluster code are indeed very related if not the same as the Salmonella Bredeney strain from New Mexico. Additionally, the clade structure revealed spatiotemporal associations between outbreaks. These associations may be used in source tracking for outbreak investigations.

This application demonstrates how BioVelocity can rapidly and accurately cluster, trace, and make inferences based on isolates and accompanied sample metadata.

### EXAMPLE 2

The Salmonella genome sequences in BioProject SRP018785 were used for this study. Associated metadata were available for most strains; these include sample name, collection date, geographic location, isolation source, and serovar. This study focused on Salmonella isolates from cilantro, because frequent contaminations have been reported over the years, and in several cases have resulted in product recall. This BioProject contains a good number of sequences from cilantro, including a few samples from foreign countries, and thus provides an opportunity to demonstrate the utility of Noblis' BioVelocity tool.

A total of 89 sequences with 250 bp paired end reads were downloaded and aligned with S. enterica serovar Typhimruium strain LT2 reference genome from NCBI nucleotide database (AE006468.1). Once completed, VCF files and alignment statistics for the reads were produced as output. Subsequently the SNP matrix was constructed with a python script developed by Noblis, and MEGA 6 software was used to generate a Neighbor Joining (NJ) tree with three S. bongori strains (ERR019454, SRR493646, SRR493652) as outgroup(7, 8). Bootstrapping was conducted 1000 times for greater accuracy.

BioVelocity allows rapid analysis of read sequences without assembly and annotation, averaging less than 20 seconds per genome with the VCF output. This is 100× faster than the current industry standard (Bowtie). Over 262,252 informative sites were identified to construct the SNP matrix for all genome sequences associated with cilantro. Different serovars of Salmonella isolated from cilantro clustered in distinct clades: Newport, Montevideo, Tennessee, and Tallahassee.

Among the Newport serovar, clustering was consistent with epidemiological information (i.e., collection date). The phylogenetic tree allows inferences of samples with incomplete data, such as missing serovars. An example is FMA0142; its position on the tree was consistent with serovar Rubislaw considering the same collection location (NY) and date (2011) as FMA0141 (FIG. 3). Because this isolate resides within the Montevideo clade, it likely relates closely with this serovar.

1. A bioinformatics system comprising:
a first food pathogen source associated with a first party;
a second food pathogen source associated with a second party; and
a bioinformatics processing facility communicatively coupled with the first food source and the second food source, wherein the bioinformatics processing facility comprises one or more processors configured to:
receive first genomic sequence data comprising a plurality of subsequences, wherein the first genomic sequence data is derived from a first food pathogen associated with the first party;
align the plurality of subsequences with a reference nucleic acid sequence, wherein the reference nucleic acid sequence is represented by an index;
identify one or more single nucleotide-polymorphisms in the first genomic sequence data;
compare, based on at least one of the identified single-nucleotide polymorphisms, the first genomic sequence data to second genomic sequence data derived from a second food pathogen associated with the second party; and
based on said comparison, determine whether the first food pathogen and the second food pathogen are of a same strain.

2. The system of claim 1, wherein the one or more processors are configured to:
provide a database storing genomic sequence data representing a plurality of food pathogens, wherein the data is represented by reference to the index;
wherein the database comprises stored metadata linking the genomic sequence data to one or more of the first party, a location, a time, and a third party, and
wherein comparing the first genomic sequence data to the second genomic sequence data comprises accessing the second genomic sequence data in the database.

3. The system of claim 1, wherein the one or more processors are configured to:
in response to determining that the first food pathogen and the second food pathogen are of the same strain, consult metadata to determine whether it is permissible to share non-confidential information about the related first and second food pathogens with the first and second parties;
if it is permissible to share non-confidential information about the related first and second food pathogens with the first and second parties, automatically transmit data to the first party indicating that the first food pathogen is associated with the second food pathogen, and automatically transmitting data to the second party indicating that the second food pathogen is associated with the first food pathogen.

4. The system of claim 3, wherein transmitting data comprises transmitting a compressed representation of one of the first or second genomic sequence data.

5. The system of claim 1, wherein comparing the first genomic sequence data to second genomic sequence data comprises constructing a matrix of common single nucleotide polymorphisms between the first and second genomic sequences, and generating a phylogenic tree.

6. The system of claim 1, wherein:
the first genomic sequence data is first gene sequence data; and
the second genomic sequence data is second gene sequence data.

7. A method for identifying pathogens in food using whole genome sequencing, comprising:
receiving first genomic sequence data comprising a plurality of subsequences, wherein the first genomic sequence data is derived from a first food pathogen associated with a first party;
aligning the plurality of subsequences with a reference nucleic acid sequence, wherein the reference nucleic acid sequence is represented by an index;
identifying one or more single nucleotide-polymorphisms in the first genomic sequence data;
comparing, based on at least one of the identified single-nucleotide polymorphisms, the first genomic sequence data to second genomic sequence data derived from a second food pathogen associated with a second party; and
based on said comparison, determining whether the first food pathogen and the second food pathogen are of a same strain.

8. The method of claim 7, further comprising:
providing a database storing genomic sequence data representing a plurality of food pathogens, wherein the data is represented by reference to the index;
wherein the database comprises stored metadata linking the genomic sequence data to one or more of the first party, a location, a time, and a third party, and
wherein comparing the first genomic sequence data to the second genomic sequence data comprises accessing the second genomic sequence data in the database.

9. The method of claim 7, further comprising:
in response to determining that the first food pathogen and the second food pathogen are of the same strain, consulting metadata to determine whether it is permissible to share non-confidential information about the related first and second food pathogens with the first and second parties;
if it is permissible to share non-confidential information about the related first and second food pathogens with the first and second parties, automatically transmitting data to the first party indicating that the first food pathogen is associated with the second food pathogen, and automatically transmitting data to the second party indicating that the second food pathogen is associated with the first food pathogen.

10. The method of claim 9, wherein transmitting data comprises transmitting a compressed representation of one of the first or second genomic sequence data.

11. The method of claim 7, wherein comparing the first genomic sequence data to second genomic sequence data comprises constructing a matrix of common single nucleotide polymorphisms between the first and second genomic sequences, and generating a phylogenic tree.

12. The method of claim 7, wherein:
the first genomic sequence data is first gene sequence data; and
the second genomic sequence data is second gene sequence data.

13. A non-transitory computer-readable storage medium comprising instructions that, when executed by a processor, cause the processor to:
receive first genomic sequence data comprising a plurality of subsequences, wherein the first genomic sequence data is derived from a first food pathogen associated with a first party;
align the plurality of subsequences with a reference nucleic acid sequence, wherein the reference nucleic acid sequence is represented by an index;
identify one or more single nucleotide-polymorphisms in the first genomic sequence data;
compare, based on at least one of the identified single-nucleotide polymorphisms, the first genomic sequence data to second genomic sequence data derived from a second food pathogen associated with a second party; and
based on said comparison, determine whether the first food pathogen and the second food pathogen are of a same strain.

14. The non-transitory computer-readable storage medium of claim 13, wherein the instructions cause the processor to:
provide a database storing genomic sequence data representing a plurality of food pathogens, wherein the data is represented by reference to the index;
wherein the database comprises stored metadata linking the genomic sequence data to one or more of the first party, a location, a time, and a third party, and
wherein comparing the first genomic sequence data to the second genomic sequence data comprises accessing the second genomic sequence data in the database.

15. The non-transitory computer-readable storage medium of claim 13, wherein the instructions cause the processor to:
in response to determining that the first food pathogen and the second food pathogen are of the same strain, consult metadata to determine whether it is permissible to share non-confidential information about the related first and second food pathogens with the first and second parties;
if it is permissible to share non-confidential information about the related first and second food pathogens with the first and second parties, automatically transmit data to the first party indicating that the first food pathogen is associated with the second food pathogen, and automatically transmitting data to the second party indicating that the second food pathogen is associated with the first food pathogen.

16. The non-transitory computer-readable storage medium of claim 15, wherein transmitting data comprises transmitting a compressed representation of one of the first or second genomic sequence data.

17. The non-transitory computer-readable storage medium of claim 13, wherein comparing the first genomic sequence data to second genomic sequence data comprises constructing a matrix of common single nucleotide polymorphisms between the first and second genomic sequences, and generating a phylogenic tree.

18. The non-transitory computer-readable storage medium of claim 13, wherein:
the first genomic sequence data is first gene sequence data; and
the second genomic sequence data is second gene sequence data.

19. A bioinformatics system comprising:
a first computer associated with a first food pathogen;
a second computer associated with a second food pathogen; and
a bioinformatics computer, communicatively coupled with the first and second computers, wherein the bioinformatics computer comprises one or more processors configured to:
receive, from the first computer, first genomic sequence data associated with the first food pathogen;
in response to receiving the first and second genomic sequence data:
align subsequences of the first genomic sequence data with a reference nucleic acid sequence, wherein the reference nucleic acid sequence is represented by an index;
identify one or more single-nucleotide polymorphisms in the first genomic sequence data; and
store a representation of the first genomic sequence data;
receive, from the second computer, second genomic sequence data associated with the first food pathogen; and
in response to receiving the second genomic sequence data:
align subsequences of the second genomic sequence data with the reference nucleic acid sequence;
identify one or more single-nucleotide polymorphisms in the second genomic sequence data;
store a representation of the second genomic sequence data;
compare, based on at least two of the identified single-nucleotide polymorphisms, the first genomic sequence data to second genomic sequence data;
based on said comparison, determine whether the first food pathogen and the second food pathogen are of a same strain; and
if the first food pathogen and the second food pathogen are determined to be of the same strain:
automatically transmitting data to indicating that the first food pathogen is associated with the second food pathogen, and
automatically transmitting data indicating that the second food pathogen is associated with the first food pathogen.

20. The system of claim 19, wherein:
automatically transmitting data to indicating that the first food pathogen is associated with the second food pathogen comprises transmitting data to a third computer associated with a source of the first food pathogen; and
automatically transmitting data indicating that the second food pathogen is associated with the first food pathogen comprises transmitting data to a fourth computer associated with a source of the second food pathogen.

21. The system of claim 19, wherein:
the first computer is a sequencing computer that generates the first genomic sequence data; and
the second computer is a sequencing computer that generates the second genomic sequence data.

22. The system of claim 19, wherein:
the first genomic sequence data is first gene sequence data; and
the second genomic sequence data is second gene sequence data.
